(19) United States
(12) Patent Application Publication
(10) Pub. No.: US 2016/0176370 A1
(43) Pub. Date: Jun. 23, 2016

(54) INVERTER ECU BRACKET WITH SLIDING TEMPSET FEATURE

(71) Applicant: Toyota Motor Engineering & Manufacturing North America, Inc., Erlanger, KY (US)

(72) Inventor: Jonathan Joseph Quijano, Ann Arbor, MI (US)

(21) Appl. No.: 14/575,237

(22) Filed: Dec. 18, 2014

(51) Int. Cl. B60R 16/03; B60R 16/02

(52) U.S. Cl. CPC B60R 16/03; B60R 16/0207

(57) ABSTRACT

The apparatus and method of the present disclosure enables a module to be connected to a wiring harness of a vehicle and installed in a confined area of the vehicle, such as within or underneath a center console. This is enabled by a bracket with an elongated slot and associated fastener disposed with the elongated slot which provides mobility of the module between a first position and a second position. In the first position, the module is located such that an installer of the module has access to connect the wiring harness to the module. In the second position, the module is tucked away in an out of the way location where it may be secured to be remain free from interference throughout the rest of the vehicle assembly process.

### FIELD OF THE INVENTION

The present disclosure relates to installation of modules in vehicles. Specifically to a bracket to installation of an electronics module in difficult to reach locations, such as underneath a center console assembly of a vehicle.

### BACKGROUND OF THE INVENTION

Modules such as electronic control units, power inverters, and the like, are known to have been installed in vehicles. These modules are connected to the vehicles wiring harness. Such modules are often held in position within the vehicle with the use of a bracket. The brackets typically will bolt to the module and to the vehicle. One example of such a bracket is disclosed in U.S. Pat. No. 8,336,657 to Dobbin et al. which discloses a support structure for an inverter system control module.

However, recent trends in vehicle design have increased number and placements requirements for various modules. These design changes include, for example, additional powertrains styles including electric and hybrid designs, more luxurious interiors with heater front and rear seats, various and sometimes multiple infotainment systems, and one or more outlets for AC power access. These various design changes have prompted placement of the module in confined and harder to reach locations throughout the vehicle. The location may make it difficult to connect the wiring harness and install the module to the vehicle in an efficient manner.

Accordingly, an improved bracket and installation is desired for connection of the various modules to the vehicle's wiring harness, and securement of the module within the vehicle.

### SUMMARY OF THE INVENTION

The present disclosure includes a bracket for securing and wiring a module into a vehicle with a wiring harness, a bracket assembly for securing a module in a vehicle with a wiring harness, and a method of securing a module into a vehicle.

The bracket for securing and wiring the module into the vehicle with the wiring harness includes a main portion having a first elongated slot for receiving a fastener to secure the module to the main portion. The elongated slot is adapted to permit the fastener to travel within the slot thereby permitting the module to slide between a first position and a second position. The module is able to slide to the first position while attached to the main portion within the vehicle. While the module is in the first position, the module is wired to the vehicle wiring harness. Additionally, the module is able to slide to the second position after being wired. In the second position, the module is secured in part by the fastener and remains in the second position for the duration of assembly.

The bracket assembly for mounting an inverter ECU within a center console of a vehicle includes a first bracket and a second bracket. The first bracket has a pair of parallel elongated slots. The second bracket supports the inverter. A pair of fasteners extends between the slots of the first bracket and the second bracket. The second bracket is slidable with respect to the first bracket from a first position to a second position.

The method of securing the module into the vehicle with a wiring harness includes the following steps. First, a bracket having an elongated slot is provided. The bracket is secured to the vehicle. Additionally, the module is secured to the bracket with the elongated slot so as to be able to slide within the elongated slot between a first position and a second position relative to the bracket and the vehicle. Next, the module is slid to the first position. While in the first position, the module is connected to the wiring harness. The module is then slid to the second position. While in the second position, the module is secured to prevent movement of the module relative to the first bracket and the vehicle.

Other features and advantages of the present invention will be readily appreciated as the same becomes better understood after reading the subsequent description taken in conjunction with the accompanying drawings.

### BRIEF DESCRIPTION OF THE DRAWINGS

FIG. 1 shows a plan side view of a vehicle center console with a cut out revealing a module and bracket assembly;

FIG. 2 shows a top perspective view of the module and bracket assembly in a second position;

FIG. 3 shows a top perspective view of the module and bracket assembly in a first position;

FIG. 4 shows a top elevation view of the module and bracket assembly; and

FIG. 5 shows a flow chart of step for a method to install the module and bracket assembly.

### DETAILED DESCRIPTION OF THE PREFERRED EMBODIMENTS

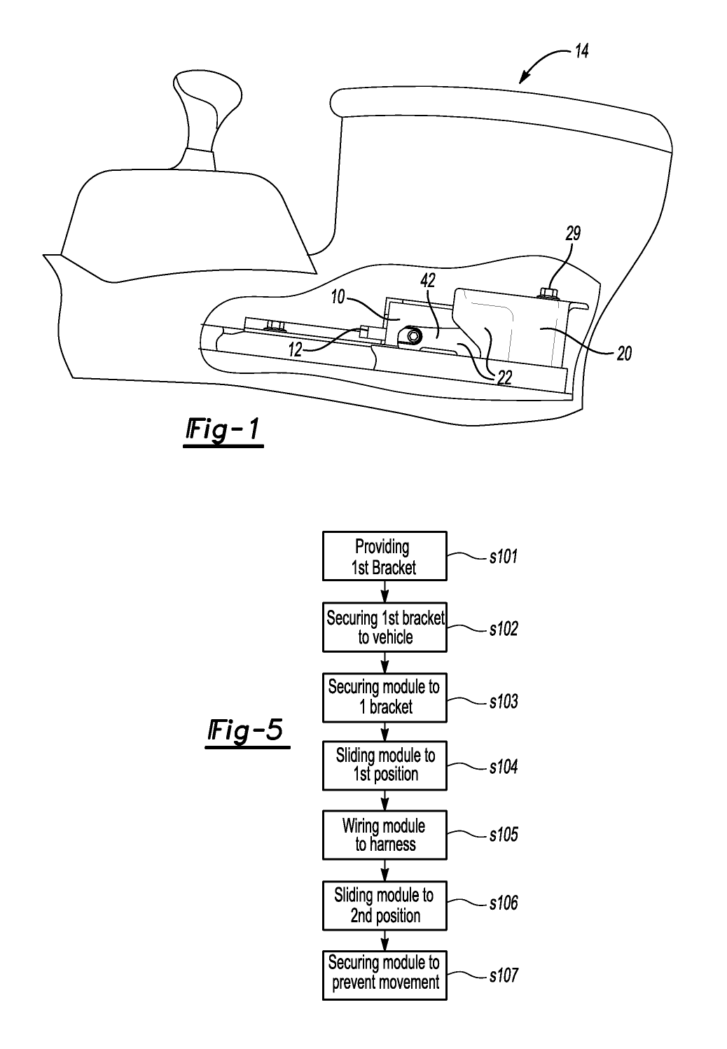

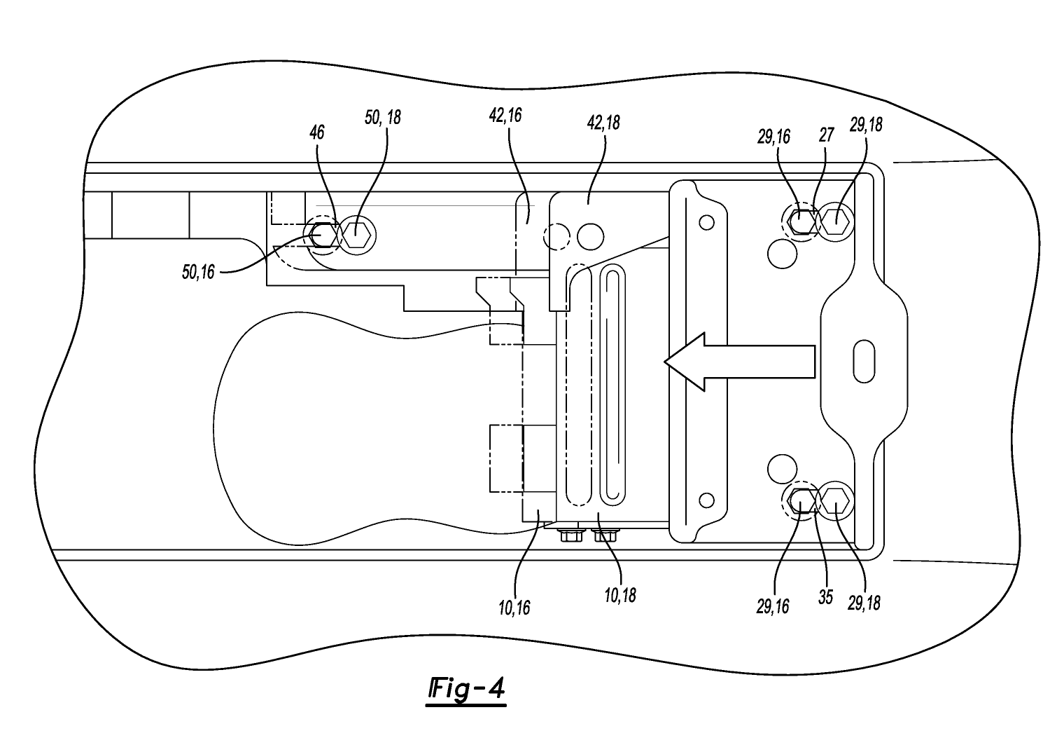

The following detailed description describes an embodiment of the present disclosure as illustrated in FIGS. 1-5.

The apparatus and method of the present disclosure enables a module 10, such as an inverter ECU, to be connected to a wiring harness 12 of a vehicle 13 and installed in a confined area of the vehicle 13, such as within or underneath a center console 14. Such confined spaces are often difficult for operators to reach, and difficult for any operator to manipulate objects within, for example connecting the inverter ECU, or module 10, to the wiring harness 12 inside of the center console 14. This disclosure is enabled by an apparatus and method of the present disclosure which provides mobility of the module 10 between a first position 18 and a second position 16. In the first position 18, the module 10 is located such that an installer of the module 10 has access to connect the wiring harness 12 to the module 10. For example, be sliding back into the center console 14 to create more room for an operator's hand. In the second position 16, the module 10 may be secured to remain free from interference throughout the rest of the vehicle assembly process.

With reference now to FIGS. 1-4 the apparatus of the present disclosure is shown. The apparatus includes a first bracket 20 for securing and wiring the module 10 into the vehicle 13 with the wiring harness 12. The first bracket 20 may be used in a bracket assembly 22 for securing the module 10 into the vehicle 13 with the wiring harness 12. The module 10 may be an electronic control unit, an inverter unit, or other electronic device needing to be connected to the wiring harness 12.

The first bracket 20 for securing and wiring the module 10 into the vehicle 13 with the wiring harness 12 includes a main portion 25 having a first elongated slot 27 for receiving a fastener 29 to secure the module 10 to the main portion 25. The elongated slot 27 is adapted to permit the fastener 29 to travel within the first elongated slot 27 thereby permitting the module 10 to slide between the first position 18 and the second position 16. The module 10 is able to slide to the first position 18 while attached to the main portion 25 within the vehicle 13. While the module 10 is in the first position 18, the module 10 is connected, or wired, to the wiring harness 12. Additionally, the module 10 is able to slide to the second position 16 after being wired. In the second position 16, the module 10 is secured in part by the fastener 29 and remains in the second position 16 for the duration of assembly.

The first elongated slot 27 in the main portion 25 is defined by a pair of generally parallel sides 31 and opposing ends 33. The generally parallel sides 31 are spaced apart along their length at a distance slightly greater than the diameter of the fastener 29 at a location on the fastener 29 disposed between the generally parallel sides 31. This spacing allows the fastener 29 to freely travel with the first elongated slot 27 in a directed parallel to the first elongated slot 27, without allow excessive slop in the motion which may make alignment of other features difficult, thus adapting the first elongated slot 27 to permit the fastener 29 and associated module 10 to move between the first position 18 and the second position 16.

In addition to the first elongated slot 27, the main portion 25 further includes a second elongated slot 35. The second elongated slot 35 is defined by generally parallel sides 31 and opposing ends 33. Similar to the first elongated slot 27, the second elongated slot 35 is adapted to permit the fastener 29 to travel within the second elongated slot 35 thereby permitting the module 10 to slide between the first position 18 and the second position 16 by way of the generally parallel sides 31 being spaced apart along their length at a distance slightly greater than the diameter of the fastener 29 at a location on the fastener 29 disposed between the generally parallel sides 31.

Further, the first elongated slot 27 and the second elongated slot 35 are aligned generally parallel to each other, thus forming a pair of parallel elongated slots. Having the first elongated slot 27 parallel to the second elongated slot 35 allows the module 10 to be linearly translated between the first position 18 and the second position 16 without rotation of the module 10. Rotation of the module 10 is restricted by having a fixed distance between the fastener 29 disposed in the first elongated slot 27 and the fastener 29 disposed in the second elongated slot 35.

Extending from the main portion 25 is a pair of securing portions 37 located near opposite ends 40 of the main portion 25. The securing portions 37 extend generally perpendicular from the main portion 25 and attach to the vehicle 13 when the first bracket 20 is installed in the vehicle 13. The main portion 25 and securing portions can be made of metal, or other suitable material. Forming the main portion 25 and securing portions 37 out of sheet metal allows the first bracket 20 to be stamped into the proper shape, and the first elongated slot 27 and the second elongated slot 35 to be formed with a punch. The securing portion 37 attached to the vehicle 13 by being welded in place, use of a fastener, snapping in place, or other suitable method known to those skilled in the art.

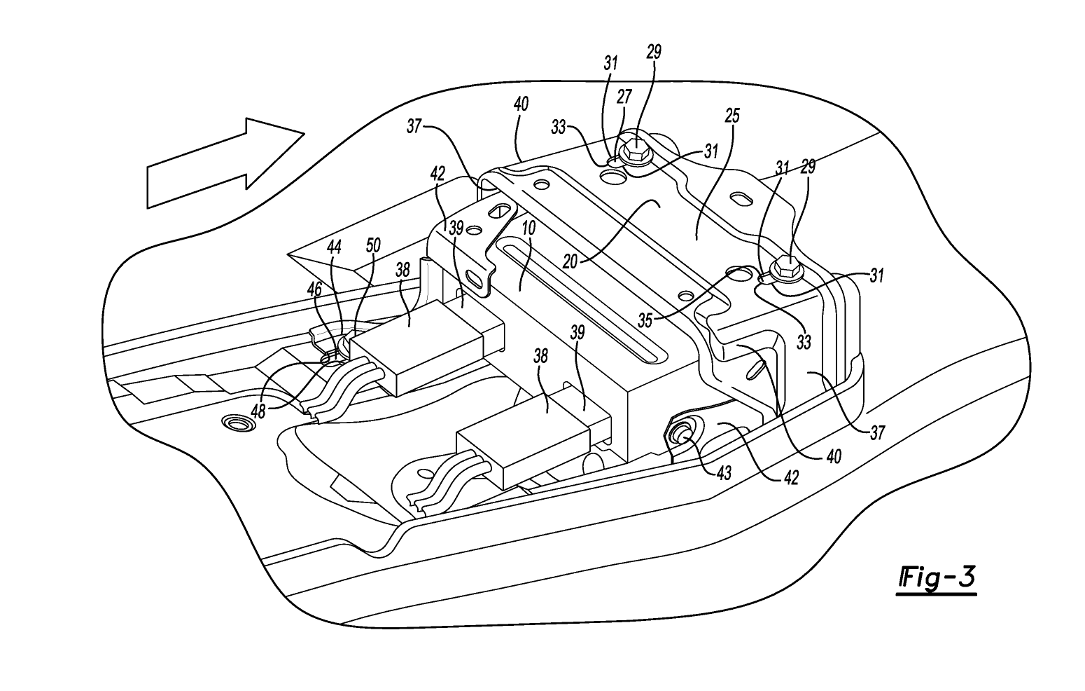

With reference now to FIG. 3, the module 10 is shown having been slid to the first position 18 while being attached to the main portion 25 of the first bracket 20. The first position 18 allows easier access by an operator who wires or connects male ends 38 of the wiring harness 12 into the female receivers 39 on the module 10.

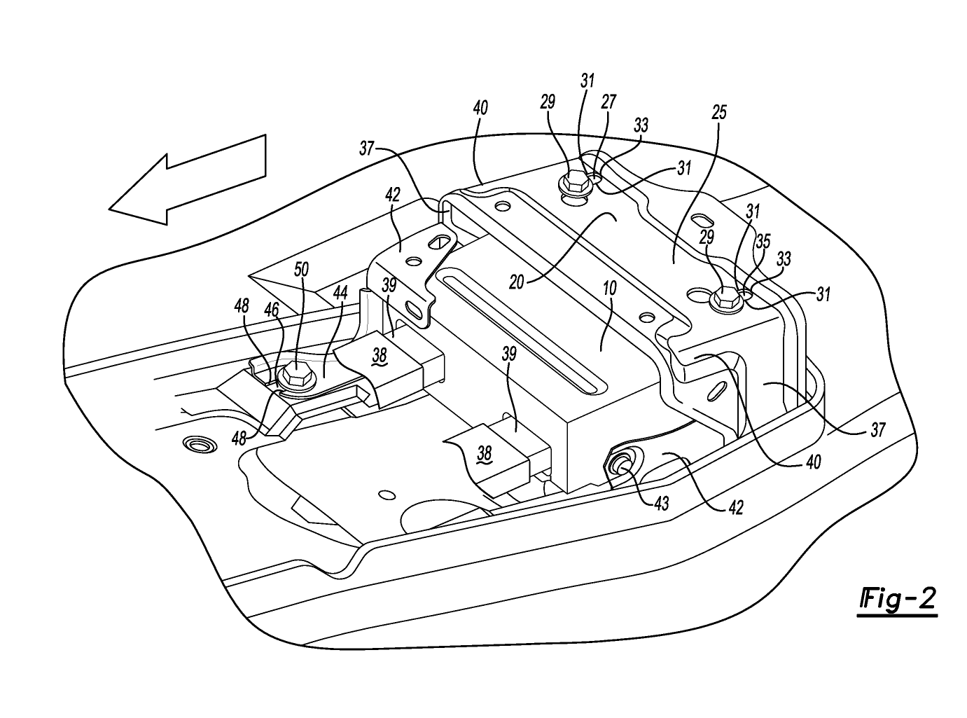

With reference now to FIG. 2, the module 10 is shown having been slide to the second position 16 after being wired or connected to the wiring harness 12. In the second position 16 the module 10 is secured in part by the fasteners 29. For example, the fasteners 29 may be tightened to clamp on the first bracket 20, alternatively the fasteners 29 may remain able to slide in the elongated slots 27 35, restricting the module 10 in all but one dimension of travel, with the module snapping into place in the second position 16. Once secured in the second position 16, the module 10 may remain in place for the duration of the assembly process.

With reference again to FIG. 1-4, the bracket assembly 22 for securing the module 10 into the vehicle 13 with the wiring harness 12 is shown. The bracket assembly includes the first bracket 20 and a second bracket 42. The first bracket 20 has the first elongated slot 27. The second bracket 42 is secured to the first bracket 20 with the fastener 29 disposed within the first elongated slot 27. The fastener 29 is able to slide within the first elongated slot 27 when the second bracket 42 is in an unfixed condition. The fastener 29 is unable to slide within the first elongated slot 27 when the second bracket 42 is in a fixed condition. Sliding the fastener 29 within the first elongated slot 27 in the unfixed condition enables the module 10 attached to the second bracket 42 to travel between the first position 18 and the second position 16. The first position 18 allows the wiring harness 12 to be wired to the module 10. The second position 16 allows the module 10 secured to be maintained free from movement when the second bracket 42 is in the fixed condition.

The first bracket 20 has been described above, including the main portion 25 and securing portions 37, and the first elongated slot 27 and the second elongated slot 35 of the main portion 25. The securing portion 37 extending from the main portion 25 to attach the first bracket 20 to the vehicle 13 when the bracket assembly 22 is installed in the vehicle 13. The first and second elongated slots 27 35 defined by generally parallel sides 31 with opposing ends 33. The generally parallel sides 31 are spaced apart such that the fastener 29 disposed between is able to travel the length of the elongated slot 27 35 with having an excessive amount of slop or play in the movement. The fastener 29 disposed in the elongated slot 27 35 is secured to the second bracket 42, whereby travel of the fastener 29 permits the second bracket 42 to move between the first position 18 and the second position 16.

The second bracket 42 is disposed between the first bracket 20 and the vehicle 13 when the bracket assembly 22 is installed. Second bracket 42 supports and is secured to the module 10 with screws 43, fasteners or other suitable means known to those skilled in the art to prohibit movement between the module 10 and the second bracket 42. The module 10 and second bracket 42 travel between the first position 18 and second position 16 in unison.

The second bracket 42 further includes an arm portion 44 that extends outwardly in the direction of travel of the second position 16 to the first position 18. The arm portion includes an arm elongated slot 46. The arm elongated slot 46 is defined by a pair of generally parallel sides 48. A fastener 50 secured to the vehicle 13 is disposed within the arm elongated slot 46, the fastener 50 able to slide relative to the second bracket 42 along the length of the arm elongated slot 46. The generally parallel sides 48 are spaced apart along their length at a distance slightly greater than the diameter of the fastener 50 at a location on the fastener 50 disposed between the generally parallel sides 48. This spacing allows the fastener 29 to freely travel with the arm elongated slot 46 in a direction parallel to the arm elongated slot 46, without allowing excessive slop in the motion. The arm elongated slot 46, the first elongated slot 27 and second elongated slot 35 are all generally parallel relative to each other, thereby providing a linear translational movement of the module 10 and the second bracket 42 between the first position 18 and the second position 16 while at the same time eliminating possible rotation of the module 10 of the second bracket 42.

The second bracket 42 may be in a fixed condition or an unfixed condition. In the unfixed condition the second bracket 42 freely moves relative to the first bracket 20 between the first position 18 and the second position 16 as discussed above. In the fixed condition, the movement of the second bracket 42 relative to the first bracket 20 is restricted. Placing the second bracket 42 into the fixed condition may be achieved by tightening the fasteners 29, thereby clamping the main portion 25 of the first bracket 20 between the head of the fastener 29 and the second bracket. Additionally, the fixed condition may be achieved by tightening the fastener 50, thereby clamping the arm portion 44 of the second bracket 42 between the head of the fastener 50 and the vehicle 13. Alternate ways of placing the second bracket 42 into the fixed condition exists, such as with a screw, fastener, clip, or any other means known to those skilled in the art suitable for inhibiting motion of the second bracket 42 relative to the first bracket 20.

The second bracket 42 made out of sheet metal, stamped and punched in proper form. Alternatively, the second bracket may be made of plastic, or with any other suitable material and method.

With reference now to FIG. 5, the method of securing the module into the vehicle with a wiring harness is laid out in flow chat form. The method includes the following steps. First, a bracket having an elongated slot is provided, step S101. The bracket is secured to the vehicle, step S102. Additionally, the module is secured to the first bracket 20 with the elongated slot so as to be able to slide within the elongated slot between a first position and a second position relative to the bracket and the vehicle, step S103. Next, the module is slid to the first position, step S104. While in the first position, the module is connected to the wiring harness, step S105. The module is then slid to the second position, step S106. While in the second position, the module is secured to prevent movement of the module relative to the bracket and the vehicle, step S107.

The provided bracket in step S101 may be similar to that described above. The bracket may include multiple elongated slots, such as the first and second elongated slots described above. The bracket may be provided as part of a bracket assembly that included a first bracket and second bracket. The second bracket may include an elongated slot, again, as described above.

After the bracket is provided in step S101, the bracket is secured to the vehicle, step S102 and the module is secured to the bracket, step S103. It is understood and appreciated that either steps S102 and S103 maybe be performed first, before the other. Preference may depend on vehicle, bracket, and assembly procedure design. The bracket maybe be secured to the module with a fastener and elongated slot, as described above. The bracket may be secured to the vehicle by welding, faster or other means. Additionally, if a bracket assembly is used, the second bracket may be secured to the vehicle with a fastener and elongated slot, as described above.

Sliding the bracket to the first position, step S104, wiring the module to the vehicle wiring harness, step S105, and sliding the module to the second position, step S106, may be done by an operator. The operator may physically slide the module to the first position and to the second position with their hands. Similarly, the operation may wire the module by connecting a male end of the wiring harness into a female received on the module. Step S104, S105, and S106 may be performed in that numerical order.

Finally, the module is secured into the second position, step S107. Securing the module into position may be achieved by tightening the fasteners, inserting additional screws, or designing in a clip that engages when the module is slid into the second position.

The present invention has been described in an illustrative manner. It is to be understood that the terminology which has been used is intended to be in the nature of words of description rather than of limitation.

Many modifications and variations of the present invention are possible in light of the above teachings. Therefore, the present invention may be practiced other than as specifically described.

1. A bracket assembly for mounting an inverter ECU within a center console of a vehicle, the bracket assembly comprising:
a first bracket having a pair of parallel elongated slots;
a second bracket supporting the inverter;
a pair of fasteners extending between the slots of the first bracket and the second bracket, said second bracket slidable with respect to the first bracket from a first position to a second position.

2. The bracket assembly of claim 1 further comprising:
the second bracket having an arm portion, the arm portion including an arm elongated slot for receiving a fastener to secure the second bracket to the vehicle, the arm elongated slot adapted to permit the fastener to slide within the arm elongated slot;
wherein sliding of the fastener within the arm elongated slot enables the inverter ECU attached to the second bracket to travel between the first position and the second position.

3. The bracket assembly of claim 2 wherein the pair of elongated slots and the arm elongated slot are generally parallel to each other.

4. A bracket for securing and wiring a module into a vehicle with a wiring harness comprising:
a main portion having a first elongated slot for receiving a fastener to secure the module to the main portion, the elongated slot adapted to permit the fastener to travel within the slot thereby permitting the module to slide between a first position and a second position;
wherein the module is able to slide to the first position while attached to the main portion within the vehicle where the module is wired to the wiring harness, and the module is able to slide to the second position after being wired where the module is secured in part by the fastener.

5. The bracket of claim 4 further comprising:
at least one securing portion extending from the main portion;
wherein the securing portion is attached to the vehicle when the bracket is installed in the vehicle.

6. The bracket of claim 5 wherein the securing portion extends generally perpendicular from the main portion.

7. The bracket of claim 4 further comprising:
the main portion having a second elongated slot for receiving a fastener to secure the module to the main portion, the elongated slot adapted to permit the fastener to travel within the slot thereby permitting the module to slide between the first position and the second position;
wherein the module is able to slide to the first position while attached to the main portion within the vehicle where the module is wired to the wiring harness, and the module is able to slide to the second position after being wired where the module is secured in part by the fastener and remains for the duration of assembly.

8. The bracket of claim 7 wherein the first elongated slot and the second elongated slot are generally parallel to each other.

9. The bracket of claim 5 wherein the main portion is made of metal.

10. A method of securing a module into a vehicle with a wiring harness comprising:
providing a first bracket having a first elongated slot;
securing the first bracket to the vehicle;
securing a module to the first bracket with the elongated slot so as to be able to slide within the elongated slot between a first position and a second position relative to the first bracket and the vehicle;
sliding the module to the first position;
connecting the module to the wiring harness while the module is in the first position;
sliding the module to the second position; and
securing the module to prevent movement relative to the first bracket and the vehicle while the module is in the second position.

11. The method of claim 10 wherein the first bracket further includes a second elongated slot.

12. The method of claim 10 wherein the module is secured to the bracket by way of a second bracket, the module being attached to the second bracket, and the second bracket receiving a fastener disposed within the elongated slot of the first bracket.

13. The method of claim 12 wherein the second bracket includes an elongated slot, the second bracket is secured to the vehicle with the elongated slot.
